(19) United States
(12) Patent Application Publication
(10) Pub. No.: US 2025/0006392 A1
(43) Pub. Date: Jan. 2, 2025

(54) NUCLEAR COGENERATION PLANT HAVING A REACTOR WITH AN INDIRECT THERMODYNAMIC CYCLE WITHOUT EXTRACTION OR DISCHARGE OF LIQUID WATER FROM/TO THE ENVIRONMENT

(71) Applicant: COMMISSARIAT A L'ENERGIE ATOMIQUE ET AUX ENERGIES ALTERNATIVES, Paris (FR)

(72) Inventors: Philippe AMPHOUX, Saint-Paul lez Durance (FR); Jean-Baptiste DROIN, Saint-Paul lez Durance (FR)

(73) Assignee: COMMISSARIAT A L'ENERGIE ATOMIQUE ET AUX ENERGIES ALTERNATIVES, Paris (FR)

(21) Appl. No.: 18/707,446

(22) PCT Filed: Oct. 31, 2022
(86) PCT No.: PCT/EP2022/080339

§ 371 Date: May 3, 2024

(30) Foreign Application Priority Data
Nov. 3, 2021 (FR) FR2111675

(51) Int. Cl. G21D 5/08; G21D 9/00

(52) U.S. Cl. CPC G21D 5/08; G21D 9/00

(57) ABSTRACT

The invention essentially consists in using in combination a thermal storage loop, arranged between the primary circuit and secondary circuit of a reactor, with a dry-air cooling device connected to the condenser of the secondary circuit.

### TECHNICAL FIELD

The present invention relates to the field of light water reactors (LWRs), and more particularly that of pressurized water reactors (PWRs).

More particularly, the invention concerns cogeneration plants comprising such nuclear reactors. Here and in the context of the invention, the term “cogeneration” is taken to mean the generation, simultaneous or otherwise, of electricity and useful heat.

The object of the invention is to utilize all the heat in the primary circuit of a nuclear reactor while maintaining the same level of service in terms of electricity generation, and consequently limiting or even eliminating any environmental impact of the reactor caused by the extraction and discharge of liquid water from/to the environment.

Although it is described with reference to a pressurized water reactor, the invention is applicable to any nuclear reactor with an indirect thermodynamic cycle in the classes of reactors known as second, third and fourth generation (GEN IV) reactors. It is particularly applicable to fast neutron reactors cooled with liquid metal, notably liquid sodium, of the type called FNR-Na or SFR (Sodium Fast Reactor), belonging to the GEN IV reactor class.

### PRIOR ART

In a context of climate and energy transition, the nuclear industry is faced with a number of challenges for the future. In order to respond to tomorrow's energy and social demands, we need to design nuclear reactors that enable us to:
limit the demands on “environmental” sources of cooling liquid (rivers, estuaries, seas) and the associated discharges into the environment;
operate more flexibly, thus supplementing other forms of energy known as “renewables”, in order to meet the fluctuating demand for power, given the intermittent nature of these renewables;
decarbonize processes by supplying heat to the industries that use it (desalination plants, heating networks, hydrogen production, etc.);
capture atmospheric CO2 in order to limit the effects of climate heating and contribute to the closure of the carbon cycle as a carbon source for industrial processes,
without any detriment to the profitability of the plant, by profiting from the new services offered or by significantly increasing the amount of power generated per day.

A pressurized water reactor (PWR) conventionally comprises three cycles (fluid circuits) whose normal operating principle is explained below with reference to FIG. 1. The temperatures and efficiencies shown are purely illustrative.

The primary circuit 1 is a closed loop fluid circuit comprising, mainly, the reactor core 2, at least one steam generator (SG), acting as what is known as a primary exchanger 3, and a hydraulic pump 4 for circulating the heat transfer fluid which is water kept in the liquid state in the thermal operating range of the reactor, typically around 320° C.-330° C. in normal operation. Other fittings, such as a pressurizer and the set of devices for ensuring operation in the requisite safety conditions, are not described here.

Thus the highly pressurized water of the primary circuit collects the energy supplied in the form of heat by the fission of the uranium nuclei in the core of the reactor 1.

This water, at a high pressure and temperature, typically 155 bar and 320° C.-330° C., then enters the intermediate exchanger 3 and transmits its energy to a secondary circuit 5, which also uses pressurized water as the heat transfer fluid in a closed loop.

This secondary circuit 5 comprises the intermediate exchanger 3, a turbine 6 comprising a high-pressure cylinder 60 and a low-pressure cylinder 61, a condenser 7 and a hydraulic pump 8 for circulating the water in vapor form that acts as the heat transfer fluid.

Thus, in this secondary circuit 5, the water in vapor form, at high pressure, typically about 70 bar, is expanded in the high-pressure cylinder of the turbine, and is then superheated before expanding further in the low-pressure cylinder 61. The turbine drives an alternator 9 that generates electricity.

The water from the secondary circuit is then condensed via the condenser 7 in a third cycle, namely the cooling cycle 10, to act as what is known as the “low-temperature” source. This cycle 10 mainly comprises wet air cooling towers 11, which are towers with hollow centers, in which a flow of air, entering in the lower part and exiting from the upper part, is naturally created. As it passes through the tower, this air flow collects the heat contained in the cooling circuit water and disperses it into the atmosphere in the form of a cloud of water vapor. The operation is repeated constantly, the water being distributed in fine droplets, providing good heat exchange between the water and the air, thus bringing the water to a temperature close to that of the ambient air, while also saturating the upward air flow circulating in the tower with water vapor. Some of the flow of water evaporates in the tower 11, while the remainder falls like rain into the pool below the tower, from which it is pumped back to cool the condenser 7. The evaporated water is replaced with tertiary water, called “environmental” water, pumped up from an estuary, a river or a sea. This substantially raises the temperature of these watercourses; consequently, in a hotter period and/or in a time of reduced flow in watercourses, a nuclear plant operator may have to reduce the power level, or even close the plant down.

As shown in FIG. 1, by way of example, the thermodynamic efficiency of a PWR is around 33% to 34%, and the water temperature is about 20° C. at the inlet of the condenser 7 and about 35° C. at its outlet.

In conventional PWR systems, reactors are categorized in major classes of use as follows:
“power generating” reactors, dedicated solely to electricity generation;
“heat generating” reactors, dedicated solely to heat generation;
“cogeneration” reactors dedicated for both electricity and heat generation, whether simultaneous or not.

As detailed in [1], the principle of nuclear reactor-based cogeneration is that the energy conversion cycle is modified so that heat is liberated at the low-temperature source at a temperature that enables it to be utilized. The limitation of global warming requires a minimization of heat losses at all levels, particularly at the level of the low-temperature source of a thermodynamic plant. This aim of cogeneration is particularly important for a nuclear reactor because heat for industrial or domestic purposes is often obtained traditionally by burning fossil fuels responsible for greenhouse gas emissions.

To achieve this aim, a first configuration consists in modifying the components of the power generating system of a PWR plant in order to adjust the water temperature at the low-temperature source.

However, in a conventional configuration, shown in FIG. 1, this modification is limited. It has no effect on the high-pressure turbine 60, but only on the low-pressure turbine 61 operating on the Rankine cycle. This modification, shown in FIG. 2, consists in bringing the operating point P of the low-pressure turbine 61 to a pressure of about one bar, instead of about 50 mbar, so that the water leaving the condenser is at a sufficiently high temperature, typically 70° C., to be utilized in a heating network 12, for example. This modification is initially accompanied by a reduction of the electrical power output, since the thermodynamic efficiency changes to 27%. There is also an increase of pressure in the condenser 7.

However, this first cogeneration configuration has two major drawbacks.

In the first place, as mentioned above, utilizing the heat of the low-temperature source decreases the electrical efficiency of the plant: the service provided in terms of electrical power is significantly degraded. This is because, as stated in the second law of thermodynamics, increasing the temperature of the low-temperature source reduces the efficiency of a conversion cycle. This phenomenon of degradation of the electrical efficiency with an increase in the temperature of the low-temperature source is illustrated by the falling curve as a function of temperature in FIG. 3, obtained from [2].

The other major drawback is that a low-temperature source in the form of liquid water extracted from an estuary, a river or a sea is still needed to supply the cooling towers 11 at times when there is no longer any demand for heat, or when the heating network is unusable. This also results in discharges of spent water to the environment and the associated restrictions on operation required for compliance with the discharge standards.

A second cogeneration configuration is one in which heat is extracted, not from the low-temperature source, but directly from the cylinders 60, 61 of the turbine 6, by drawing off hot steam: see [3] and [4]. This second configuration, shown in FIG. 4, with a draw-off S between the two cylinders 60, 61 or within these cylinders, has the advantage of having higher temperatures, typically above 100° C., than those obtained when the heat is taken from the low-temperature source. These higher temperatures are potentially compatible with industrial applications, without significant degradation of the electrical efficiency if the thermal power drawn off remains limited. However, this second configuration has the drawbacks of allowing only limited amounts of thermal power to be drawn off, in order to avoid unacceptable degradation of the electrical efficiency, and to avoid limiting the environmental liquid water requirement for cooling the conversion circuit. The water requirement and the associated discharges are therefore still very significant in this configuration.

Concepts having the aim of limiting the intrinsic faults of cogeneration systems by adding an energy storage installation have already been proposed in the literature. These concepts may be grouped in two major classes, as follows.

The first class is concerned with systems for improving the maneuverability of the reactor, in other words aiming to make the power generation of the reactor more flexible than it is at present, by temporarily increasing the level of electrical power supplied to the grid in order to match it to demand. In the literature, these systems are implemented with power-generating reactors, but this approach is also applicable to cogeneration reactors: see [5], patent application JP2020197468A.

An example of such a system is shown schematically in FIG. 5. A supplementary fluid circuit configured as a heat storage loop 13 is arranged between the primary circuit 1 and the secondary circuit 5 where the energy conversion takes place.

This loop 13 comprises, respectively, the intermediate exchanger 3, two heat storage reservoirs, one of which is called the high-temperature reservoir 14 while the other is called the low-temperature reservoir 15, a steam generator 16 for exchanging heat between the storage loop and the secondary circuit and thus generating steam for the turbines 60, 61, and finally two hydraulic pumps 17, 18, located, respectively, between the high-temperature reservoir 14 and the steam generator 16 and between the low-temperature reservoir 15 and the intermediate exchanger 3, for moving the heat transfer fluid within this loop 13. The heat transfer fluid in this loop is advantageously a mixture of HITEC® molten salts with the composition 53% KNO₃, 40% NaNO₂, 7% NaNO₃. By way of example, the temperature of this heat transfer fluid is 310° C. in the high-temperature reservoir 14, while it is about 245° C. in the low-temperature reservoir 15.

In a system shown in FIG. 5, the reactor core 2 operates in base-load mode, that is to say at 100% power, throughout the operating cycle. The power extracted to the storage loop 13 is constant, and is maintained by the pump 18 upstream of the intermediate exchanger 3.

In times of low demand, the pump 17 downstream of the high-temperature reservoir that discharges power to the secondary circuit is in low output mode. The high-temperature reservoir 14 fills and the low-temperature reservoir 15 empties. The power transferred to the secondary circuit 5 is therefore less than that generated in the core 2.

When demand is high, the pump 17 is in overdrive, and the power transferred to the secondary circuit 5 therefore exceeds what is generated in the core. Thus this system has the advantage of decoupling the operation of the reactor core from that of the energy conversion system in the secondary circuit, while increasing the electrical power supplied to the grid at times of high demand.

However, such a system has a number of major drawbacks, as follows:
it does not allow the temperature of the water leaving the condenser 7 to be raised, and therefore this temperature remains very low, typically below 40° C., and cannot be utilized;
it requires a general over-dimensioning of the conversion cycle, including the low-pressure turbine cylinders 61, which have to be very bulky, since the thermal power transferred to the secondary cycle 5 is greater in the daytime;
it also requires an over-dimensioning of the low-temperature source, since the latter is adapted to discharge the residual power from the secondary cycle that has been over-dimensioned.

The second class of cogeneration systems in which an energy storage installation is added consists of installations designed to improve the overall energy efficiency of the plant, in other words to exploit some of the heat generated in addition to electricity. An example of an added installation is described in U.S. Pat. No. 4,170,879A.

FIG. 6 also shows a system belonging to this second class, in which the thermal power of the core is controlled by the electrical power demand of the grid. Here, a heat storage reservoir 19 is arranged downstream of the condenser 7. This reservoir 19 enables the water of the low-temperature source leaving the condenser 7 to be stored, and then returned at another time. With this configuration, therefore, it is possible to utilize some or all of the waste heat of the reactor in addition to the electricity supplied to the grid, and to temporarily decouple the supply of electrical power from that of thermal power.

However, such a system has a number of major drawbacks, as follows:
the core cannot operate in base load mode, and therefore the power generated in the core varies according to the electrical demand;
the temperature utilized remains very low, typically below 40° C., which limits the applications;
if the conversion cycle in the secondary circuit 5 is modified to raise the temperature of the utilized heat, the electrical efficiency of the plant is degraded significantly;
since the storage reservoir 9 is directly connected to the heating network 12, it must have very large dimensions, since storage is at a relatively low temperature, typically 40° C.;
it requires a considerable water supply in situations where the heating network is not available, or when there is no heat demand (in summer).

Briefly, all the nuclear cogeneration plants identified in the literature are such that:
either only a small part of the heat can be utilized, to avoid significant degradation of the electrical efficiency, in which case the low-temperature source requirement remains very considerable and much of the power generated in the reactor core cannot be utilized;
or a large part of the heat of the reactor can be utilized, but only by significantly degrading the electricity generation, so that in an extreme case the reactor generates nothing but heat, thus considerably, or even unacceptably, impacting the profitability of a given plant. Consequently there is a need to improve nuclear cogeneration plants in order to allow the utilization of all the heat generated in the primary circuits of reactors of the plants, thus limiting or even eliminating any environmental impact of the reactors of the plants, that is to say the extraction and discharge of liquid water from/to the environment.

This need is confirmed by the nuclear authorities: see [6].

The object of the invention is to provide at least a partial response to this need.

### SUMMARY OF THE INVENTION

To this end, the invention relates, in one of its aspects, to a nuclear cogeneration plant comprising:
at least one nuclear reactor, notably a pressurized water reactor (PWR), comprising:
   a first fluid circuit, called the primary circuit, comprising at least a first intermediate heat exchanger;
   a second fluid circuit, called the secondary circuit, comprising at least one steam generator acting as a second intermediate heat exchanger, at least one turbine connected to the second heat exchanger, a condenser connected to the turbine and to the second heat exchanger for cooling the steam leaving the turbine, converting it back into water, and returning it to the second heat exchanger;
   an alternator coupled mechanically to the turbine and designed to be connected to an electricity grid;
a third fluid circuit configured as a closed loop for storing thermal energy, in which there flows a heat transfer fluid comprising:
   at least a first reservoir, called the high-temperature reservoir, connected to the first intermediate heat exchanger;
   at least a first hydraulic pump, connected to the high-temperature reservoir and to the second intermediate heat exchanger;
   at least a second reservoir, called the low-temperature reservoir, connected to the second intermediate heat exchanger;
   at least a second hydraulic pump, connected to the low-temperature reservoir and to the first intermediate heat exchanger;
at least one dry-air cooling device connected in a closed loop to the condenser of the secondary circuit of the reactor.

The invention allows the following tasks to be performed simultaneously:
causing the reactor to operate at its nominal design operating rate (K_{d}), also called the availability coefficient, independently of the power demand of the electricity grid connected to the alternator;
utilizing in the best possible way some or all of the thermal energy generated by the reactor, to provide new energy services (heating, hydrogen production, etc.);
at least partially avoiding the requirement for liquid water as a cooling source, together with the associated discharges, contributing to the process of dissipating energy that is not utilized.

As a corollary, the invention enables the safety of the plant to be improved by the provision of a device contributing to residual power discharge for reactor downtimes.

Essentially, the invention consists in utilizing a heat storage loop arranged between the primary circuit and the secondary circuit of a reactor, combined with a dry-air cooling device connected to the condenser of the secondary circuit.

The resulting cogeneration plant is a system having total or practically total energy efficiency, which responds to the challenges for flexibility of the electricity grid associated with the large-scale introduction of renewables and the problems of the climate transition, since it no longer needs a water supply.

Thus, by coupling the circuits of a nuclear reactor with a heat storage loop, it is possible to design a plant enabling 100% of the energy generated in the core to be utilized, without degrading the service delivered in terms of daytime electricity generation.

Advantageously, the invention is a combination of the following means:
a heat storage loop installed on site between the primary circuit and the secondary circuit of a reactor, notably a PWR. Because of this heat storage loop, the operation of the reactor is no longer controlled by the requirements of the electricity grid. Because of the storage of thermal energy, the reactor constantly operates at full power, and the energy conversion system in the secondary circuit delivers the power according to the requirements of the grid (in daytime), thus increasing the amount of electricity sent to the grid.

Since the thermal power supplied in daytime to the conversion system in the secondary circuit is greater than for a prior art plant, while the thermodynamic efficiency is lower, it may be necessary to over-dimension the steam generators and the high-pressure turbine cylinders, notably with a large blade diameter.

The dimensioning of the low- and high-temperature reservoirs of the storage loop depends on the required temperature level. The volume of the reservoirs is advantageously between 10,000 m³ and 30,000 m³, the industrial feasibility of such reservoirs being established, in view of current practice in other industrial fields;
an increase of the temperature of the water leaving the condenser of the secondary circuit, on the low-temperature source side, to a utilizable temperature, typically more than 70° C. for an urban heating network for example, which reduces the conversion efficiency of the thermodynamic Rankine cycle in the secondary circuit. This may advantageously result in a significant reduction, or even the elimination, of the low-pressure cylinders of the turbine(s) and a modification of the condenser design, notably with an increase in its saturation pressure;
an increase in the low temperature on the low-temperature source side of the electrical conversion circuit in the secondary circuit, that is to say at the condenser inlet, typically to more than 40° C., so as to make it accessible in case of an absence of heat, whether momentary or otherwise, for the urban heating network, this being made possible by the use of dry-air cooling technology to replace the conventional wet air cooling towers that are major water consumers.

These dry-air cooling towers need no liquid water for cooling, regardless of the consumer or the heat requirement. It is atmospheric air that acts as the coolant.

A major advantage of a system configuration according to the invention, as compared with a plant according to FIG. 5 and patent JP2020197468A, lies in the addition of a complementary component/process/network that modifies the technical and functional configuration of the plant:
configuration A/: addition of a dry-air cooling tower, obviating the need for a water source for the waste heat discharge process;
configuration B/: connection to an urban heating network, called a low-temperature network, to increase the overall energy efficiency of the plant.

The inventors have overcome a technical prejudice based on the view that the maximization of electricity generation to ensure the profitability of a nuclear plant always requires the plant to be designed with the lowest possible temperature of the low-temperature source.

In fact, by coupling the addition of a heat storage loop with the over-dimensioning of the design power of the Rankine cycle, the invention makes it possible to change the paradigm, by demonstrating the possibility of providing cogeneration with very high energy efficiency.

In the final analysis, a nuclear cogeneration plant having a PWR with a heat storage loop and a dry-air cooling device according to the invention has numerous major advantages, for the same level of service provision in terms of daytime electricity generation, among which may be mentioned:
a very high energy efficiency, because, in the configuration with an urban heating network in nominal conditions, each MW generated in the core is utilized;
the absence of any draw-off or discharge of liquid water into the environment, regardless of the operating conditions of the plant;
the elimination of the need to construct a nuclear plant on the coast or on a tidal river with a high rate of flow;
the absence of any environmental constraints due to climate disruption (heatwaves);
drastic simplification of safety demonstrations;
increased potential for deploying plants in countries with dry climates with no estuaries, rivers or seas in their geography;
better public acceptance.

Other, secondary, advantages due to the invention may be mentioned:
constant base-load operation of the PWR, since the power variation is provided by the heat storage loop;
a simplified design of the primary circuit of the PWR of the plant;
a simplification of the safety specifications for the plant;
major gains in the operation of the plant;
improved availability, etc.;
reduction in the volume of waste per MWh;
the possibility of discharging residual power from the reactor core during reactor downtimes, using the heat storage loop, notably with the reserve of heat transfer fluid contained in the low-temperature reservoir. The detailed conditions associated with this functionality will be specified according to the expected safety level.

Advantageously, the dry-air cooling device is a dry-air cooling tower.

According to an advantageous embodiment, the dry-air cooling device is connected as a bypass of a connection to an urban heating network.

In this embodiment, the condenser inlet temperature T1 is preferably at least 40° C., and the condenser outlet temperature T2 is preferably at least 70° C.

Advantageously, each of the low-temperature and high-temperature reservoirs has a volume of between 10,000 m³ and 30,000 m³.

Also advantageously, the heat transfer fluid of the heat storage loop is a molten salt or a mixture of molten salts adapted to remain in liquid phase over a temperature range from 100° C. to 350° C., with a margin of 40° C. relative to the maximum operating temperature of the heat storage loop.

The heat transfer fluid preferably has the following chemical composition: 53% NaNO₃, 40% NaNO₂, 7% KNO₃.

According to an advantageous variant embodiment, the turbine or turbines have no low-pressure cylinders.

Other advantages and features of the invention will be more readily apparent from a perusal of the detailed description of examples embodiment of the invention, provided by way of non-limiting illustration, with reference to the following figures.

### BRIEF DESCRIPTION OF THE DRAWINGS

FIG. 1 shows schematically a configuration of a pressurized water reactor (PWR) acting solely as a power generating reactor according to the prior art.

FIG. 2 is a schematic view of a configuration of a pressurized water reactor (PWR) modified to operate as a cogeneration reactor according to the prior art.

FIG. 3 shows, in the form of curves, the variation of the electrical efficiency and the exergy of a prior art PWR as a function of the temperature of the low-temperature source.

FIG. 4 is a schematic view of another configuration of a pressurized water reactor (PWR) modified to operate as a cogeneration reactor according to the prior art.

FIG. 5 is a schematic view of a configuration of a cogeneration plant comprising a pressurized water reactor (PWR) and a heat storage loop according to the prior art.

FIG. 6 is a schematic view of a configuration of a cogeneration plant comprising a pressurized water reactor (PWR) and a heat storage loop according to the prior art.

FIG. 7 is a schematic view of a configuration of a cogeneration plant comprising a pressurized water reactor (PWR), a heat storage loop and a dry-air cooling device according to the invention.

FIG. 8 is a schematic view of a configuration of a cogeneration plant comprising a pressurized water reactor (PWR), a heat storage loop, a heating network and a dry-air cooling device acting as a bypass for the heating network according to the invention.

FIG. 9 shows in graphic form the intra-day demand power curve of an electricity grid, connected to a PWR according to the prior art.

FIG. 10 shows in graphic form the power curve of a PWR in a cogeneration plant with a heat storage loop according to the invention.

### DETAILED DESCRIPTION

Throughout the present application, the terms “upstream” and “downstream” are to be interpreted with respect to the direction of flow of a heat transfer fluid within one of the fluid circuits of a nuclear cogeneration plant according to the invention.

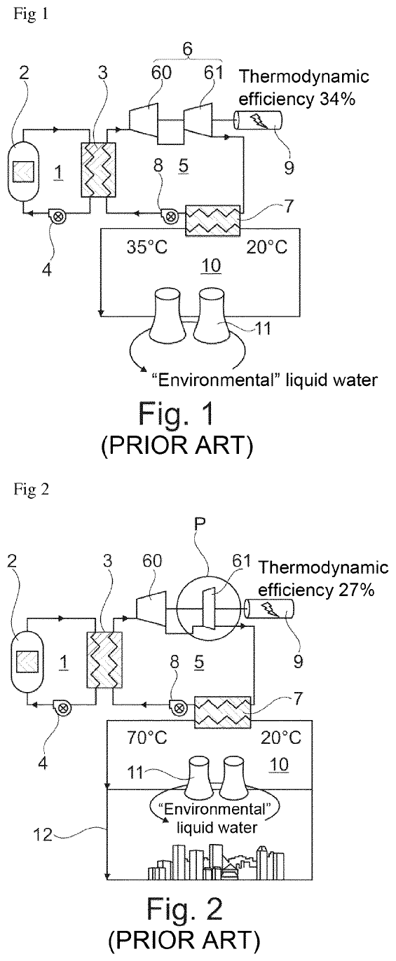

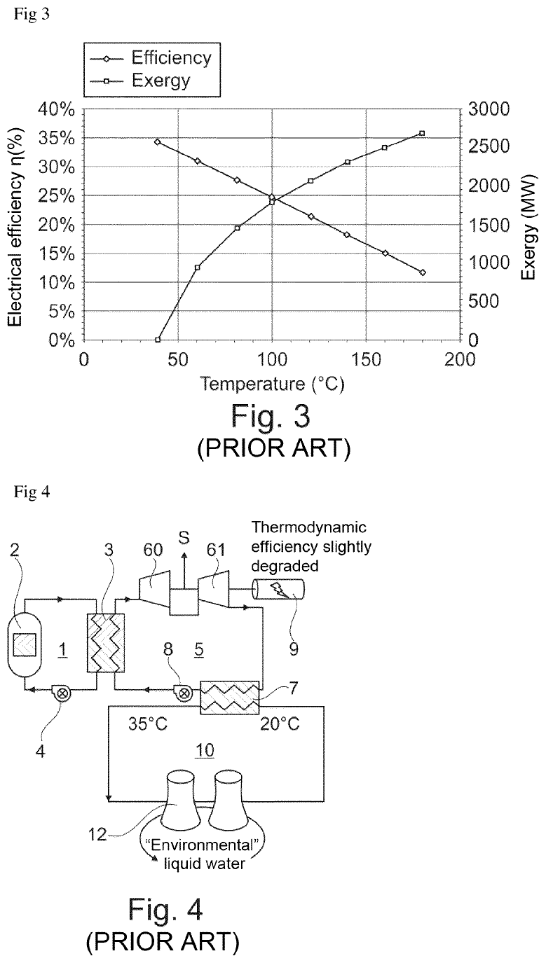

FIGS. 1 to 6, relating to the prior art, have already been detailed in the preamble, and will therefore not be remarked upon henceforth.

For the sake of clarity, an element that is the same in the invention as it is in the prior art is designated by the same reference numeral throughout FIGS. 1 to 10.

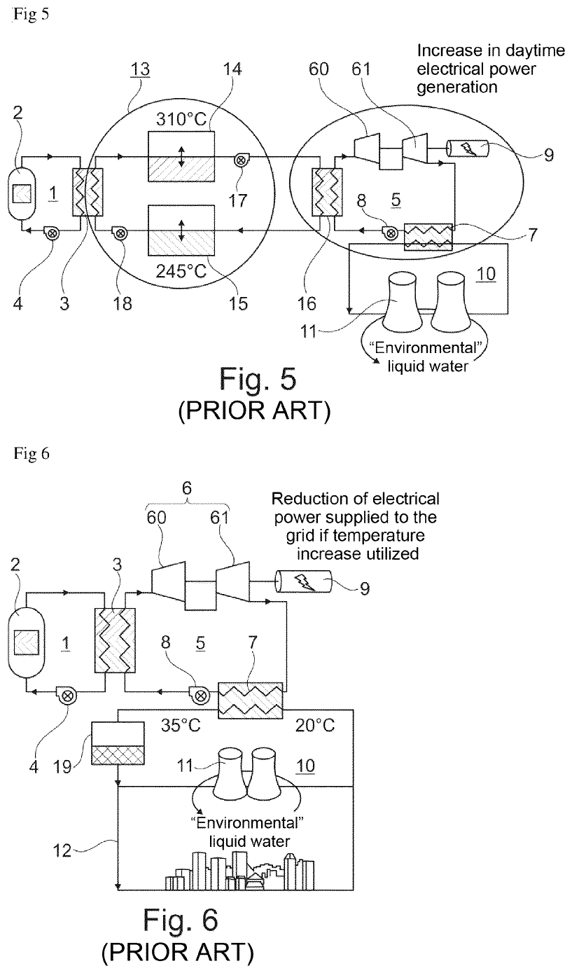

Not all of the various relations and functions of the elements common to both a cogeneration plant according to the invention and a cogeneration plant with a heat storage loop according to the prior art, as shown in FIG. 5, will be detailed again. Only some of these elements are described again.

The nuclear cogeneration plant according to the invention shown in FIG. 8 comprises, in addition to the usual components of an ordinary PWR plant, a heat storage loop 13 between the primary circuit 1 and the secondary circuit 5, together with a dry-air cooling device 20.

The heat storage loop 13 is a closed loop fluid circuit in which a heat transfer fluid circulates from the intermediate exchanger 3 of the primary circuit of the reactor to a high-temperature reservoir 14, and then into a steam generator 16 and into a low-temperature reservoir 15, before returning to the intermediate exchanger 3.

The heat transfer fluid is circulated within the loop 13 by a hydraulic pump 17 downstream of the high-temperature reservoir 14 and a hydraulic pump 18 downstream of the low-temperature reservoir 18.

The fluid branches of the loop 13 are each formed by a pipe of cylindrical section, with metal walls resistant to chemical attack by the heat transfer fluid at high temperatures, typically above 300° C., which is thermally insulated on the outside with a high-temperature insulator. The diameter of a pipe is calculated to enable all the thermal power to be discharged with the maximum permissible limit flow velocity of the heat transfer fluid, typically about 5 to 10 m/s.

The high-temperature reservoir 14 can contain the heat transfer fluid, store all the heat recovered from the intermediate exchanger 3, and supply the steam generator 16 with heat transfer fluid. The high-temperature reservoir 14 can be of cylindrical shape, having walls of metal that withstands the chemical attack by the heat transfer fluid at high temperature, typically above 300° C., and is coated with an external high-temperature insulating layer to limit heat losses. The dimensioning (useful storage volume) of the high-temperature reservoir 14 depends on the characteristics of the heat transfer fluid used: it must enable the reservoir to store all the heat generated by the nuclear reactor over a rolling period of 24 hours. For reasons of safety, the high-temperature reservoir 14 is located at a distance, typically, according to a preliminary estimate, at a distance of 60 m from the reactor enclosure, with an intermediate slope. The reservoir 14 may be fitted with a system for preheating the heat transfer fluid, to ensure that the fluid is kept in the liquid state, and/or with a level measurement system with an alarm indicator and/or a safety overflow connected directly to the low-temperature reservoir 15.

The steam generator 16 generates the steam for the turbines 60, 61, which is characteristic of a Rankine cycle with the operating modes of an electricity generating cycle of the plant, and must be able to operate according to the requirements of the electricity grid 21. The steam generator 16 is typically dimensioned to discharge 1.5 times the power of the nuclear reactor. It should be noted that the turbines 6, 60, 61 are dimensioned on the basis of the peak steam flow generated by the steam generator 16.

The hydraulic pump 17, like the hydraulic pump 18, is designed to operate at least at the coefficient of availability Kd of the nuclear reactor and must be able to operate according to the fluctuations of the electricity requirements of the electricity grid 21 to which the alternator 9 of the nuclear reactor is electrically connected. The flow rate of the pump 17 or 18 must be sufficient, with allowance for the heat capacity of the heat transfer fluid and the dimensions of the steam generator 16, to supply the latter with heat transfer fluid at a flow rate that enables the power demand of the electricity grid 21 to be met. Each of the pumps 17, 18 has metal walls that withstand the chemical attack of the heat transfer fluid at high temperatures, typically above 300° C. A number of pumps 17 or 18 can be positioned in parallel to distribute the pumping flow, and a redundant pump can be provided for safety reasons.

The low-temperature reservoir 15 has substantially the same heat transfer fluid storage volume as the high-temperature reservoir 14, the heat transfer fluid being recovered from the steam generator 16. The low-temperature reservoir 15 can be of cylindrical shape, having walls of metal that withstands chemical attack by the heat transfer fluid at high temperatures, typically above 300° C., and is coated with an external high-temperature insulating layer to limit heat losses. The dimensioning (useful storage volume) of the low-temperature reservoir 15 depends on the characteristics of the heat transfer fluid used: it must enable the reservoir to store all the heat generated by the nuclear reactor over a rolling period of 24 hours. For reasons of safety, the low-temperature reservoir 15 is located at a distance, typically, according to a preliminary estimate, at a distance of 60 m from the reactor enclosure, with an intermediate slope. The reservoir 15 may be fitted with a system for preheating the heat transfer fluid, to ensure that the fluid is kept in the liquid state, and/or with a level measurement system with an alarm indicator and/or a safety overflow connected directly to the high-temperature reservoir 14.

The heat transfer fluid is of the molten salt type, in order to remain in the liquid phase over a temperature range from 100° C. to 350° C., with a margin of 40° C. relative to the maximum operating temperature. Preferably, the salt will have the following chemical composition: 53% NaNO₃, 40% NaNO₂, 7% KNO₃ (HITEC® salt).

The total volume of salt contained in the closed loop 13 is equal to the total volume of the low-temperature reservoir 15 and the volume contained in the fluid branches/pipes of the loop 13, in order to avoid any overflow or loading in operation.

The electricity grid 21 connected to the alternator 9 is designed to transport and distribute electricity to the end users according to their requirements. It is a high-voltage electricity grid operating according to the power demand determined by the electricity use, and it must accept the peak electrical power generated by the cogeneration plant.

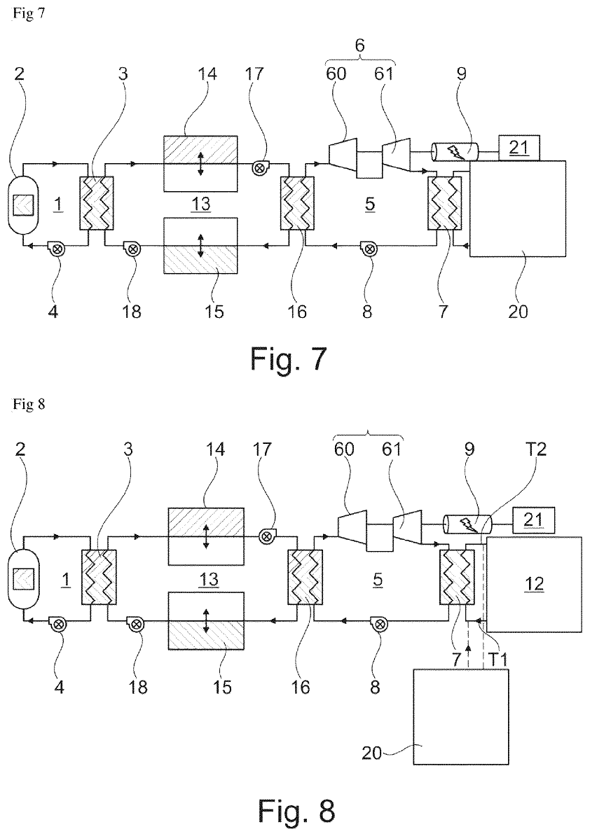

According to the invention, the cogeneration plant comprises at least one cooling tower 20, called a dry-air cooling tower, that is to say one that operates in dry mode, being connected in a closed loop to the condenser 7 of the secondary circuit of the reactor. This configuration, referred to below as configuration A/, is shown in FIG. 7.

This cooling tower 20 will transfer the heat of the water condensed in the condenser 7 to the ambient air.

The cooling tower 7 is dimensioned so as to discharge the thermal power not consumed by the turbines 6, 60, 61, by bringing the water supplied from the condenser 7 to the lowest temperature that the ambient air can permit by heating up in a substantial manner.

Although not shown, the closed loop comprising the condenser 7 and the dry-air cooling tower 20 is fitted with a pumping system to carry the heat transfer fluid within it, this pumping system possibly being directly incorporated in the tower 20. This configuration A/ is intended for operation purely for power generation, with the residual power not consumed by the electrical conversion system 6, 9 being discharged via the dry-air cooling tower 20. In this configuration A/, the plant is not running at total energy efficiency, but has the important advantage of generating more electricity in the daytime than a prior art PWR, without the need to extract or discharge liquid water from/to the environment.

In an advantageous configuration, referred to below as configuration B/ and illustrated in FIG. 8, the dry-air cooling tower 20 is connected as a bypass of a connection to an urban heating network 12.

Thus, if the service for the heating network 12 stops, the plant operates in configuration A/.

This configuration B/is intended for operation with cogeneration, for supplying low-temperature heat to an urban heating network 12.

Therefore, in case of a momentary absence of the heat requirement for this network, the plant returns to configuration A/.

Typically, the whole cogeneration plant is configured so that, in the closed loop incorporating the condenser 7 and the urban heating network 12, it has a condenser inlet temperature T1 of at least 40° C. and a condenser 7 outlet temperature T2 of at least 70° C.

The inventors have undertaken the dimensioning of the cogeneration plant illustrated in FIGS. 7 and 8 for configurations A/ and B/ respectively.

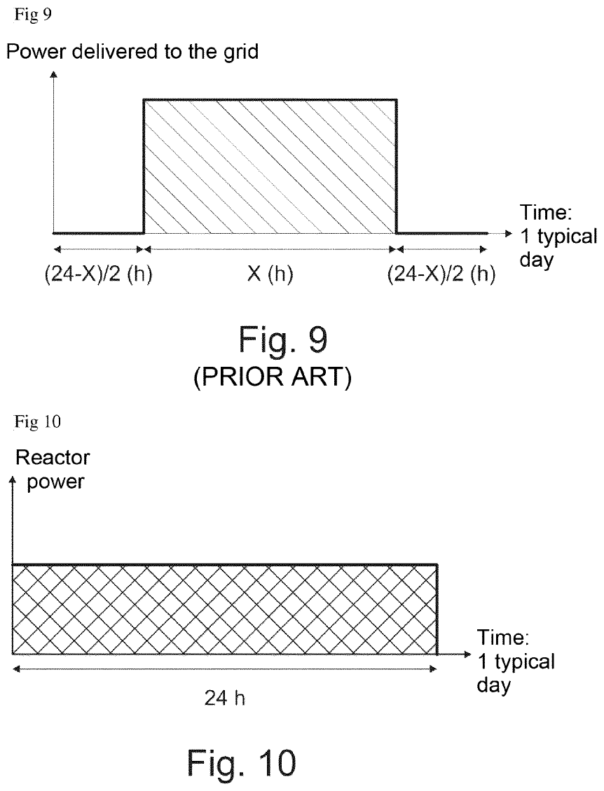

This dimensioning is based on the intra-day demand power curve of a high-voltage electricity grid 21. To simplify the dimensioning calculation, the power curve can be simplified as in FIG. 9, with a constant requirement in terms of power centered over a period of X hours in the day, where X is less than 24.

Although the requirement is not identical to this simplification in reality, the design of the plant according to the invention remains the same, given that the total power delivered to the grid daily is equal to the integral of the power delivered over a rolling 24 hour period.

### Comparative Configuration

In a PWR configuration according to the prior art, as shown in FIG. 1, the water at the inlet of a wet-air cooling tower 11 is at about 35° C., and is at 25° C. at the outlet.

In this case, the total power delivered daily to the grid by the system will be:

$${P}_{Daily elec grid} ( MWhe / j ) = X ( h ) \times {P}_{Reactor} ( MWth ) \times {Rdt}_{Rankine 25 °} ( \% ) \qquad ( 1 )$$

with, in this case, an efficiency of Rdt_{Rankine} 25°=33%

### Configuration A/ and B/ According to the Invention

By introducing the storage loop 13, the operation of the reactor can be decoupled from the requirements of the power curve of the electricity grid 21. Thus the total power generated by the reactor is given by equation (2) below:

$${P}_{D aily reactor} ( MWth ) = 24 \times {P}_{Reactor} ( MWth ) \% ) \qquad ( 2 )$$

This constant power is illustrated in FIG. 10.

To be able to deliver all of this power to the grid daily, the energy conversion loop 5 implementing a Rankine cycle must therefore be dimensioned so as to discharge all of its power during the X hours of the power request of the grid.

Its design power is then given by equation (3)

$${P}_{Rankine} ( MWhe ) = \frac{24}{X} \times {P}_{Reactor} ( MWhth ) \times {Rdt}_{Rankine} \qquad ( 3 )$$

On the basis of these daily power budgets, the elements of the heat storage loop 13 can be dimensioned.

For the input data, given the choice of the PWR technology, the temperatures at the terminals of the intermediate exchanger 3 are fixed, and therefore the temperatures in the low-temperature reservoir 15 and the high-temperature reservoir 14 are, respectively:

$${T}_{salt low} = 245 ° C .$$

$${T}_{salt high} = 310 ° C .$$

In these conditions, the salt pumping flow rate of the pump 18 is given by the equation:

$${Q}_{Feed pump EI} ( {m}^{3} / s ) = \frac{{P}_{R e actor} ( MWth )}{C {p}_{salt} \times ( {T}_{salt high} - {T}_{salt low} )} \qquad ( 4 )$$

where Cpₛₐₗₜ is the heat capacity per unit mass of the heat transfer fluid in the loop 13.

The design of the intermediate exchanger 3 is given by the equation:

$${P}_{R e a c t o r} ( MWth ) = K \times S \times Δ T {T}_{L n} \qquad ( 5 )$$

where:
K is the mean surface heat transfer coefficient,
S is the exchange surface,
ΔTT_{Ln} is the delta logarithmic temperature of the temperature at the terminals of the intermediate exchanger 3.

The useful volume of the high-temperature reservoir 14 is then given by the formula:

$${V}_{useful high - temp reservoir} ( {m}^{3} ) = 24 {Q}_{Feed pump EI} ( {m}^{3} / h ) \qquad ( 5 )$$

By design, the useful volume of the low-temperature reservoir 15 is equal to the useful volume of the high-temperature reservoir 14:

$${V}_{useful low - temp reservoir} ( {m}^{3} ) = {V}_{u seful high - temp reservoir} ( {m}^{3} ) \qquad ( 6 )$$

This design procedure does not allow for the loss of volume during the hours of recovery of operation of the reactor and of the electricity conversion cycle. However, it provides a kinetics for the stopping of the reactor in case of failure of the energy conversion system at the least favorable moment (the start of the grid request cycle). The total volume of the low-temperature reservoir before overflow may be given by adding a safety volume, which in a preliminary estimate, before the safety analysis, is considered to be 20% of the useful volume.

The flow rate of the feed pump 8 of the steam generator 16 is given by the following equation:

$${Q}_{Feed pump GV} ( {m}^{3} / h ) = \frac{{V}_{u s eful high - temp reservoir} ( {m}^{3} )}{X ( h )} \qquad ( 7 )$$

The design of the components of the Rankine cycle in the secondary circuit 5 is dictated by the thermal power to be converted and the temperature at the terminals of the condenser 7.

The thermal power is given by the aforesaid equation (3).

The temperature at the terminals of the condenser 7 depends on the envisaged configuration A/ or B/.

Table 1 below shows the values of temperature and efficiency of the associated thermodynamic cycle as a function of the configuration A/ or B/.

TABLE 1

| Configuration | A/ | B/ |
|---|---|---|
| T° hot (T2) condenser 7 (° C.) | 50 | 70 |
| T° cold (T1) condenser 7 (° C.) | 40 | 50 |
| Efficiency of the Rankine cycle (%) | 30 | 27 |
| implemented by the secondary circuit 5 | | |

The design of all the components of the cycle is determined on the basis of an in-house software, used under the name CYCLOP, qualified by the applicant for the design of a thermodynamic conversion cycle in permanent conditions.

The use of this software is described, for example, in [3] and [7]. The design can also be carried out using another commercially available software product, notably the product having the trade name of THERMOFLEX®.

As a preliminary step, the raising of the temperature at the terminals of the condenser 7 simplifies the number of turbines 6, or may even reduce their size, due to the removal of the low-pressure cylinders 61.

The generic input data used are:
a pressurized water reactor (PWR) of the type currently used in the French nuclear power fleet,
a reactor core power level of 100 MWth.

For each of the configurations A/ and B/, the operating point of the energy conversion system in the secondary circuit is calculated with the CYCLOP software.

For configuration A/, performance evaluations indicate:
a thermodynamic efficiency of 30.1%, which is degraded relative to a conventional PWR configuration, for which the efficiency is about 34%, owing to the increase of the temperature of the low-temperature source to 50° C.;
a daytime electrical power output of 44.61 MWe for a 100 MWth reactor. By way of reminder, a conventional PWR would produce about 34 MWe in the daytime. Here, the daytime electrical power generation is boosted by the storage of the energy produced overnight by the storage loop 13.
a total absence of any liquid water requirement for cooling, since the low-temperature source requirement corresponds to a temperature of 40° C., compatible with the use of a dry-air cooling tower 20. This temperature level is reached by modifying the pressure in the condenser 7 from about 50 mbar to about 160 mbar. This is accompanied by a reduction in the dimensions of the low-pressure turbine cylinders 61 and a simplification of the condenser design.

For configuration B/, performance evaluations indicate:
a thermodynamic efficiency of 26.4%;
a daytime electrical power output of 37.90 MWe for a 100 MWth reactor;
100% utilization of the energy generated by the reactor when there is a sufficient heat requirement for the urban heating network 12;
a total absence of any liquid water requirement for cooling, even when there is no heat requirement, which is compatible with the use of a dry-air cooling tower 20.

Table 2 below summarizes the performance evaluations for the configurations A/and B/that were studied.

TABLE 2

| | | PWR | Con- | Con- |
|---|---|---|---|---|
| | | configuration | figu- | figu- |
| | | according to | ration | ration |
| Data/performance | Unit | the prior art | A/ | B/ |
| Thermal power of the | MWth | 100 | 100 | 100 |
| reactor | | | | |
| Number of hours/day of | hrs | 16 | 16 | 16 |
| power request in the | | | | |
| electricity grid 21 | | | | |
| Thermal power of the | MWth | 100 | 150 | 150 |
| Rankine cycle 5 | | | | |
| Temperature T1 of the | ° C. | 35 | 50 | 80 |
| condenser 7 | | | | |
| Efficiency of the | % | 34 | 30.1 | 26.4 |
| Rankine cycle 5 | | | | |
| Electrical power | MWhe/d | 544 | 722.4 | 632.4 |
| generated per day | | | | |
| Increase in electricity | % | N.A. | 33 | 16 |
| generation | | | | |
| Electrical power | MWhe/d | 544 | 722.4 | 632.4 |
| generated per day and | | | | |
| sent to the electricity | | | | |
| grid 21 | | | | |
| Thermal power | MWth/d | N.A. | N.A. | 1767.6 |
| generated per day and | | | | |
| delivered to the urban | | | | |
| heating network 12 | | | | |

These evaluations confirm and quantify the advantages of the invention described above for configurations A/ and B/, and notably:
when the system no longer needs liquid water for waste heat removal, the increase in the energy efficiency of the plant increases. This is because, in configurations A/and B/, the amount of electricity generated per day increases by 3 to 33%;
as well as being favorable in terms of environmental impact, the invention increases the economic competitiveness of a nuclear plant.
true cogeneration without any loss of electricity generation, particularly for urban heating.

The invention is not limited to the examples described above; notably, it is possible to combine characteristics of the illustrated examples in variants that have not been illustrated.

Other variants and embodiments would be feasible without departure from the scope of the invention.

The nuclear cogeneration plant described above in relation to a pressurized water reactor can also be implemented with all nuclear reactors having indirect thermodynamic cycles, for which the heat production cycle is physically separated from the energy conversion cycle.

### LIST OF REFERENCES CITED

[1]: “Améliorer l'efficacité énergétique en utilisant la cogénération dans la production d'électricité” Jean-Marie Loiseaux, Henri Safa, Bernard Tamain, Réseau Sauvons le Climat.
[2]: “Heat recovery from nuclear power plants”, H. Safa, International Journal of Electrical Power & Energy Systems, Volume 42, Issue 1, November 2012, Pages 553-559
[3]: H. D. Nguyen, N. Alpy, D. Haubensack. “Insight on electrical and thermal powers mix with a Gen2 PWR: Rankine cycle performances under low to high temperature grade cogeneration.” Energy, Elsevier, 2020, 202, pp. 117518. ff10.1016/j.energy.2020.117518ff. ffcea-02569231f.
[4]: “Cogeneration with District Heating and Cooling”, Henri Safa CEA Nuclear Energy Division Scientific Direction, IAEA Consultant meeting, Vienna, 19-22 Dec. 2011.
[5]: “Two-tanks heat storage for variable electricity production in SFR: preliminary architecture and transient results”, J. B. Droin, D. Haubensack, D. Barbier, L. Brissonneau, P. Dienot, P. Gauthe, ICAPP 2019—International Congress on Advances in Nuclear Power Plants France, Juan-les-pins—2019 May 12 | 15.
[6]: “Advances in Nuclear Power Process Heat Applications”, IAEA-TECDOC-1682, INTERNATIONAL ATOMIC ENERGY AGENCY VIENNA, 2012.
[7]: D. Haubensack et al., “The COPERNIC/CYCLOP computer tool: pre-conceptual design of generation 4 nuclear systems. HTR-2004”. 2nd International Topic Conference for the HTGR, Sep. 22-24, 2004, Beijing, China, 2004.

1. A nuclear cogeneration plant, comprising:
at least one nuclear reactor, comprising:
a first fluid circuit, called the primary circuit, comprising at least a first intermediate heat exchanger;
a second fluid circuit, called the secondary circuit, comprising at least one steam generator acting as a second intermediate heat exchanger, at least one turbine connected to the second heat exchanger, a condenser connected to the turbine and to the second heat exchanger for cooling the steam leaving the turbine, converting the steam back into water, and returning the water to the second heat exchanger;
an alternator coupled mechanically to the turbine and designed to be connected to an electricity grid;
a third fluid circuit configured as a closed loop for storing thermal energy, in which there flows a heat transfer fluid, comprising:
at least a first reservoir, called the high-temperature reservoir, connected to the first intermediate heat exchanger;
at least a first hydraulic pump, connected to the high-temperature reservoir and to the second intermediate heat exchanger;
at least a second reservoir, called the low-temperature reservoir, connected to the second intermediate heat exchanger;
at least a second hydraulic pump, connected to the low-temperature reservoir and to the first intermediate heat exchanger; and
at least one dry-air cooling device connected in a closed loop to the condenser of the secondary circuit of the reactor.

2. The nuclear cogeneration plant as claimed in claim 1, wherein the dry-air cooling device is a dry-air cooling tower.

3. The nuclear cogeneration plant as claimed in claim 1, wherein the dry-air cooling device is connected as a bypass of a connection to an urban heating network.

4. The nuclear cogeneration plant as claimed in claim 3, wherein the condenser inlet temperature is at least 40° C., and the condenser outlet temperature is at least 70° C.

5. The nuclear cogeneration plant as claimed in claim 1, wherein each of the low-temperature and high-temperature reservoirs has a volume of between 10,000 m³ and 30,000 m³.

6. The nuclear cogeneration plant as claimed in claim 1, wherein the heat transfer fluid of the heat storage loop is a molten salt or a mixture of molten salts adapted to remain in liquid phase over a temperature range from 100° C. to 350° C., with a margin of 40° C. relative to the maximum operating temperature of the heat storage loop.

7. The nuclear cogeneration plant as claimed in claim 6, wherein the heat transfer fluid has the following chemical composition: 7% NaNO₃, 40% NaNO₂, 53% KNO₃.

8. The nuclear cogeneration plant as claimed in claim 1, wherein the turbine or turbines have no low-pressure cylinders.

9. The nuclear cogeneration plant of claim 6, wherein the nuclear reactor is a pressurized water reactor (PWR).
